(19) United States
(12) Patent Application Publication
(10) Pub. No.: US 2020/0101584 A1
(43) Pub. Date: Apr. 2, 2020

(54) AUTOMATED LINEAR VACUUM DISTRIBUTION VALVE

(71) Applicant: Alta Devices, Inc., Sunnyvale, CA (US)

(72) Inventors: Steven Giro YOSHIDA, San Jose, CA (US); Khurshed SORABJI, San Jose, CA (US); Minh NGUYEN, Milpitas, CA (US); Eric SANFORD, San Francisco, CA (US); Dan PARKER, San Jose, CA (US)

(21) Appl. No.: 16/149,893

(22) Filed: Oct. 2, 2018

(51) Int. Cl. B25B 11/00

(52) U.S. Cl. CPC B25B 11/005; B23B 31/307

(57) ABSTRACT

Aspects of a system for holding workpieces in place during processing are described. In an example, the system includes a distribution manifold coupled to a vacuum source, and multiple linear valves coupled to the distribution manifold, where each linear valve has a manifold with multiple openings and is adjustable to select one or more of the multiple openings to have a path to the vacuum source through the distribution manifold for providing a vacuum to hold a workpiece in place. In another example, the system includes a vacuum holder having a first array of openings, a system of linear valves positioned below the vacuum holder and having a second array of openings that aligns with the first array of openings, and a vacuum source that provides vacuum for holding a workpiece on the vacuum holder. A method for holding workpieces in place during processing using these systems is also described.

### BACKGROUND OF THE DISCLOSURE

Aspects of the present disclosure generally relate to techniques for using vacuum to hold work materials in place during a processing operation.

In various industrial operations, including those in which photovoltaic devices and/or photovoltaic modules are handled or assembled, it is common to use a vacuum table to secure or hold work materials or workpieces in place. A typical vacuum table consists of a large flat surface with a number holes or openings that allow for the area directly beneath the workpiece to have a path to a vacuum source through a vacuum distribution system such that vacuum produced by the vacuum source creates a pressure or force under the workpiece that holds the workpiece in place on top of the vacuum table. The vacuum source is typically a vacuum pump such as a Venturi vacuum pump, for example. The holes in the vacuum table that are not covered by the workpiece may be plugged, valved off, or sealed. This may not always be possible and/or may be time consuming. Therefore, any holes that remain open would represent leaks and the vacuum source and the vacuum distribution system would need to have sufficient capacity to make up or compensate for such leaks in order to maintain the pressure or force needed to hold down the workpiece.

Accordingly, techniques that allow for more efficient operations of vacuum tables or similar devices that reduce vacuum leaks and therefore reduce or eliminate the need for additional capacity of the vacuum source and/or the vacuum distribution system are desirable.

### SUMMARY OF THE DISCLOSURE

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its purpose is to present some concepts of one or more aspects in a simplified form as a prelude to the more detailed description that is presented later.

The present disclosure describes a device or system to automatically control the flow of air to a vacuum chuck array or vacuum table/table top such that parts of various size (e.g., square or rectangular workpieces) can be secured with a minimum amount of air loss through uncovered openings in the vacuum chuck array or the vacuum table/table top.

In an aspect, a system for holding workpieces in place during processing is described that includes a distribution manifold coupled to a vacuum source, and multiple linear valves coupled to the distribution manifold, where each linear valve has a manifold with multiple openings and is adjustable to select one or more of the multiple openings to have a path to the vacuum source through the distribution manifold for providing a vacuum to hold one or more of the workpieces in place.

In another aspect, a system for holding workpieces in place during processing is described that includes a vacuum holder having a first array of openings, a system of linear valves positioned below the vacuum holder and having a second array of openings that aligns with the first array of openings, and a vacuum source to provide a vacuum for holding one or more of the workpieces on the vacuum holder. The system of linear valves includes multiple linear valves and a distribution manifold coupled to the vacuum source and to the multiple linear valves, where each linear valve includes a manifold with multiple openings, where each linear valve is adjustable to select one or more of the multiple openings in the manifold to have a path to the vacuum source through the distribution manifold, and where the second array of openings includes the multiple openings of the manifolds of the multiple linear valves.

In another aspect, a method for holding workpieces in place during processing is described that includes providing a system of linear valves positioned below a vacuum holder on which one or more of the workpieces are placed during processing, where the vacuum holder has a first array of openings and the system of linear valves has a second array of openings aligned with the first array of openings. The method further includes dynamically selecting a subset of openings from the second array of openings for which a path to a vacuum source is to be provided by adjusting one or more of multiple linear valves included in the system of linear valves, where the subset of openings from the second array of openings is selected based on a number of the workpieces to be held in place on the vacuum holder. The method may additionally include applying a vacuum provided by the vacuum holder through the subset of openings from the second array of openings and through their respective openings in the first array of openings in the vacuum holder.

### BRIEF DESCRIPTION OF THE DRAWINGS

The appended drawings illustrate only some implementation and are therefore not to be considered limiting of scope.

FIG. 1 is a diagram that illustrates an example of a vacuum chuck with plugs and cord for isolation in accordance with aspects of this disclosure.

FIG. 2A is a diagram that illustrates an example of a cross-sectional side view of a linear vacuum valve in accordance with aspects of this disclosure.

FIG. 2B is a diagram that illustrates an example of a top view of a linear vacuum manifold of the linear vacuum valve in FIG. 2A in accordance with aspects of this disclosure.

FIG. 2C is a diagram that illustrates the linear vacuum valve of FIG. 2A with a workpiece in accordance with aspects of this disclosure.

FIGS. 3A-3D are diagrams that illustrate various examples of top views of an array of linear vacuum valves being used to hold down different workpieces in accordance with aspects of this disclosure.

FIGS. 4A and 4B are diagrams that illustrate examples of top view of additional arrangements of multiple linear vacuum valves being used to hold down different workpieces in accordance with aspects of this disclosure.

FIG. 5 is a flow chart that illustrates an example of a method for holding workpieces in place during processing in accordance with aspects of this disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts.

Vacuum tables are a common way of securing flat bottomed parts for precision work operations. A typical vacuum table will have a flat upper surface with an array of holes in its surface and a large chamber or manifold beneath the surface to draw air through the holes. The pressure to the chamber/manifold is usually supplied by a pump or blower connected to it through some type of ducting. It is the difference in pressure between the part/table interface and atmospheric pressure above the part is what secures the part to the table.

In a flexible automated manufacturing process it is desirable for such a vacuum table be configurable in such a way that material being processed on the table can be of different sizes and/or shapes. Ideally, the table will only have holes open to the vacuum passages where the part rests directly above. Any holes that remain uncovered represent additional air that the vacuum pump has to draw from the manifold to maintain the necessary holding pressure. As the amount of air the vacuum pump needs to remove from the system increases so will the size of the pump and the power necessary to drive it. In some manufacturing operations, such as in the assembly of a matrix of photovoltaic devices into photovoltaic modules, for example, the need to provide or make available additional vacuum capacity can add significant costs to the overall operation.

The typical solution to minimizing the number of uncovered holes is some kind of valve system that will close off holes that the work part does not cover. This solution can become difficult to implement when the range of part sizes that a vacuum table needs to accommodate is very large. The difficulty in design comes from the large the number of valves (and associated ducting) needed to control all the possible configurations.

The solution provided in this disclosure offers a means of progressively adding vacuum openings to a vacuum supply manifold such that square or rectangular sized work pieces of varying size can be accommodated with a minimum amount of automated control hardware and pneumatic connections.

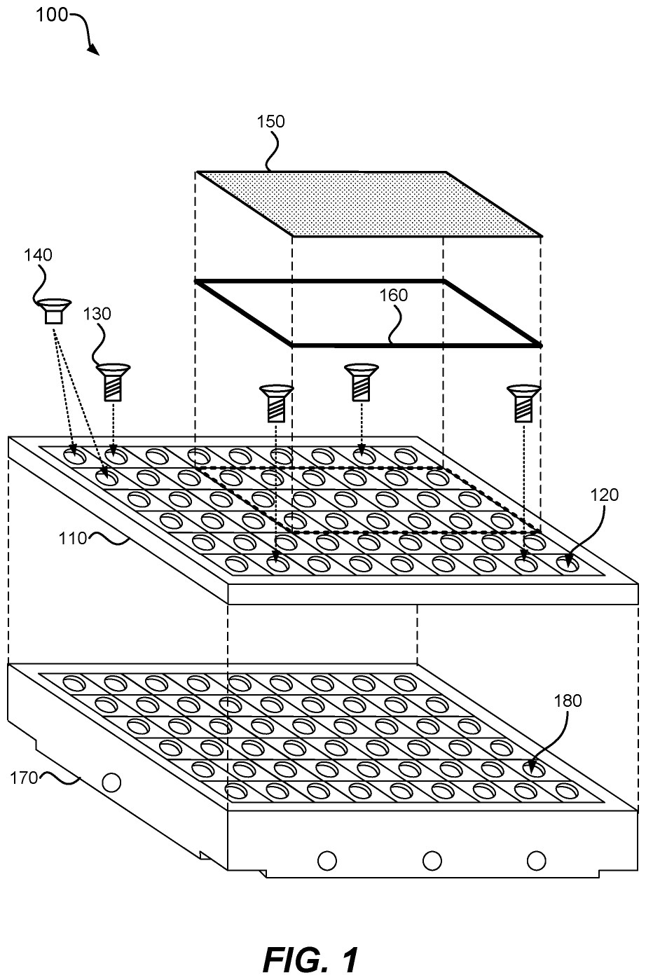

FIG. 1 shows a diagram 100 that illustrates an example of a vacuum table. In this example, a vacuum table may consist of a vacuum chuck 170 on top of which a replaceable top plate 110 can be positioned. The vacuum table, the vacuum chuck 170, and/or the top plate 110 can be referred to as a vacuum holder or simply a holder, and a workpiece 150 (e.g., a photovoltaic cell or other work material) can placed over the vacuum holder for processing. The top plate 110 has multiple holes 120 that line up or align with a respective one of multiple holes 180 in the vacuum chuck 170. Vacuum is applied through the holes 180, and also through their respective holes 120, to create a force that pulls the workpiece 150 down tightly against the top surface of the top plate 110 to facilitate handling of the workpiece 150 (e.g., having the workpiece 150 in a fixed position) during a processing operation (e.g., an assembly operation). Although the holes 120 and 180 are shown to be arranged in a rectangular array, other array configurations may also be possible such as square arrays, hexagonal arrays, to name a few. In this disclosure, the terms “holes” and “openings” may be used interchangeably to indicate apertures that may be used to provide a path to a vacuum source in order to provide or apply vacuum to hold the workpiece 150 in place. Moreover, in this disclosure, the terms “vacuum table,” “vacuum chuck,” “top plate,” “vacuum holder,” and “holder” may be used interchangeably to describe a device, component, or structure on which to place the workpiece 150. Also, in this disclosure, the concept of an “open” hole refers to a hole or opening having open access or an open path to vacuum and the concept of a “closed” hole refers to hole or opening having access or a path to vacuum closed or blocked.

The top plate 110 can be held in place, e.g., attached to the vacuum chuck 170, by using one or more screws 130, where each of the screws 130 can be threaded through a hole 120 in the top plate 110 and into a respective hole 180 in the vacuum chuck 170. The holes through which the screws 130 are threaded may be chosen so as to not interfere with the placement of workpiece 150 on the top plate 110. That is, because the screws 130 essentially plug the holes through which they are threaded, those holes may not be used to provide vacuum suction to hold the workpiece 150 in place. Accordingly, it is generally preferred, but not essential in all cases, that the workpiece 150 be placed or positioned on an area of the top plate 110 that is void of screws 130. Other types of mechanical fasteners may also be used to attach, adjoin, or affix the top plate or holder 110 to the vacuum chuck 170.

To avoid vacuum leakage and to better isolate the holes that are to be used for providing the vacuum that pulls and holds the workpiece 150 in place on top of the top plate 110, multiple plugs 140 can be used to plug or cap the remaining holes, that is, those holes not directly below the workpiece 150. Moreover, a gasket cord 160 can be placed between the workpiece 150 and the top plate 110, where the gasket cord 160 provides a mechanical seal such that the vacuum that is applied via the holes directly below the workpiece 150 does not leak out through the sides of the workpiece 150.

There may be different types of operations that use a vacuum table like the one described above in connection with the diagram 100 in FIG. 1. For example, a matrix assembly tool for making photovoltaic modules by arranging multiple photovoltaic devices can use a vacuum table. In some cases, the matrix assembly tool may require that unused areas in the vacuum table (e.g., holes not being used to provide vacuum to hold down a workpiece) be manually covered with a combination of Polyethylene terephthalate (PET) film and tape, or by using some other type of cover material or plug. Other techniques such as valve schemes to close unused holes, for example, tend to be difficult since each cell (e.g., hole) or set of cells (e.g., set of holes) would require a valve and separate manifold. For example, in a typical 1 m×1 m work/vacuum table used for a photovoltaic assembly operations and having 20 rows and 58 columns of holes, a matrix of 1160 valves and associated manifolds would be required, making such a solution cumbersome and expensive.

Leaving areas in the vacuum table or vacuum chuck uncovered (e.g., holes not being used to provide vacuum to hold down a workpiece are not covered or plugged) becomes costly as the as the area increases. For example, multiple blowers may be needed to produce sufficient vacuum and the operating costs (e.g., electricity costs) of running those blowers could be very high, even when not including the load on an air conditioning system. Finding efficient and practical ways to avoid vacuum leakage can significantly reduce these costs.

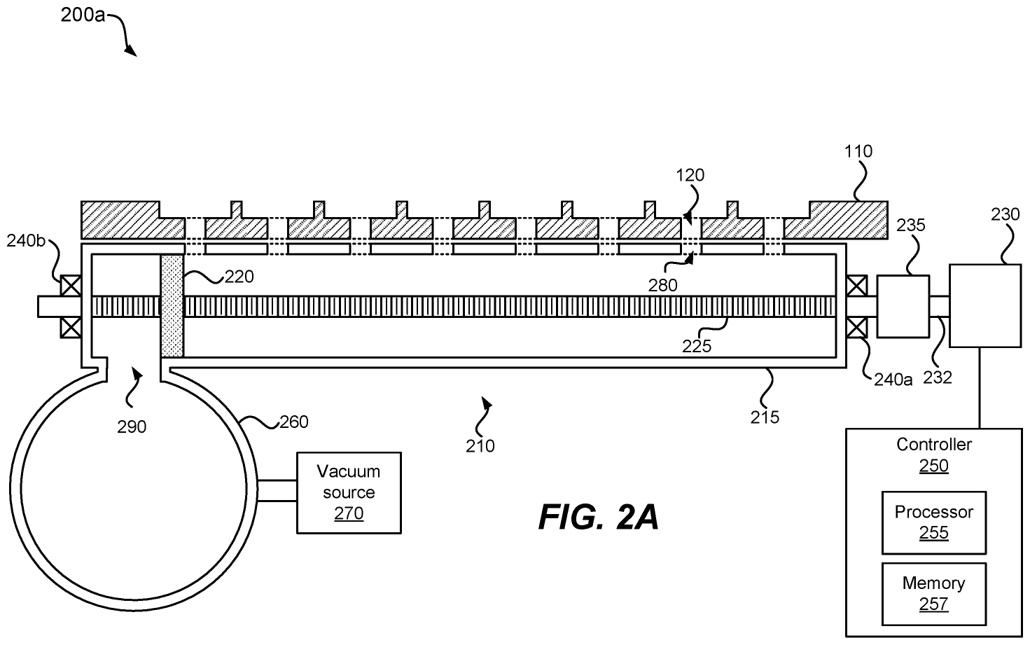

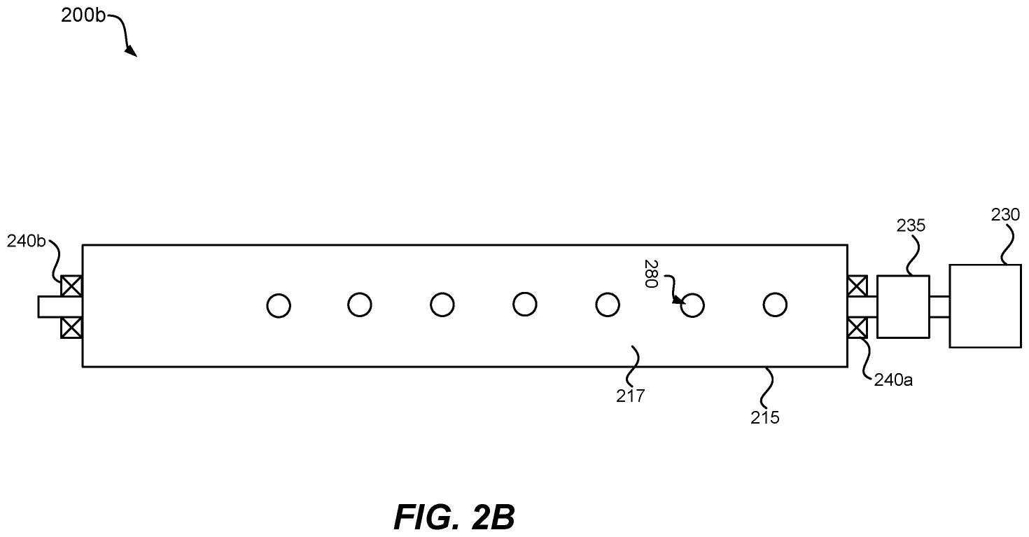

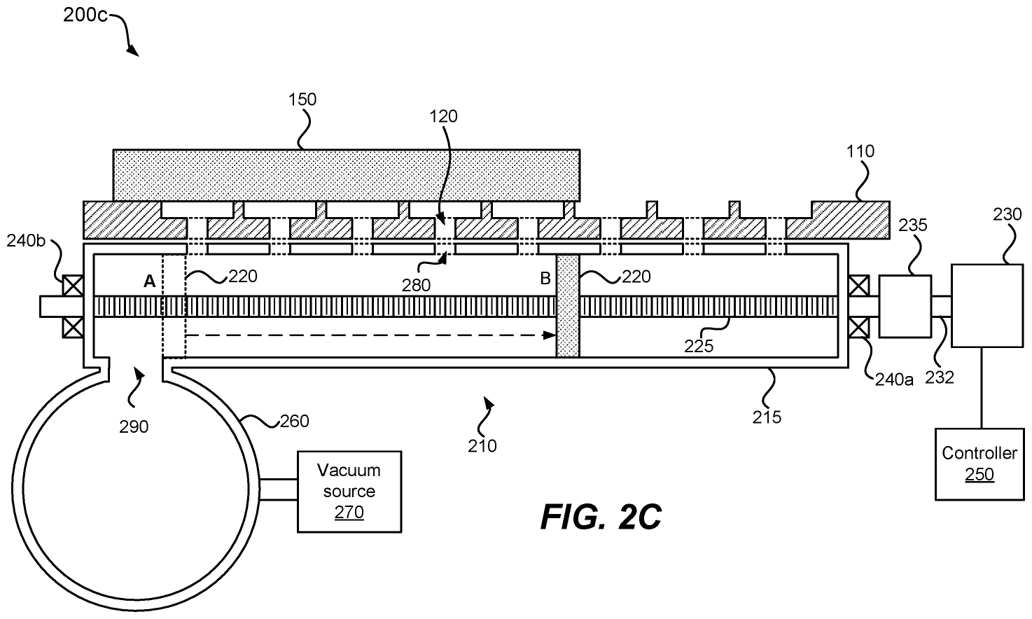

FIG. 2A shows a diagram 200a that illustrates a cross-sectional side view of a linear vacuum valve 210 in accordance with aspects of this disclosure. The linear vacuum valve 210 overcomes some of the issues described above by allowing the holes in a vacuum table or vacuum chuck to remain closed (e.g., no vacuum leakage) and using electromechanical means be able to select which holes to open to provide vacuum at appropriate locations to hold a workpiece in place. This approach provides better control of the application of vacuum to when holding down a workpiece and also avoids the need for manual and/or inefficient covering or plugging of holes.

The linear vacuum valve 210 may include a linear valve manifold 215 that is an elongated member having a proximal end that connects to a distribution manifold 260 via a vacuum input 290, and having a distal end opposite the proximal end where a motor 230 and a motor coupling 235 are positioned. The distribution manifold 260 is connected to a vacuum source 270 (directly or through one or more vacuum conduits) that provides the vacuum to be applied by the linear vacuum valve 210. The distribution manifold 260 may be connected to multiple linear vacuum valves 210 at the same time to provide access to vacuum to each of the linear vacuum valves 210.

The linear valve manifold 215 can be a circular, square, or rectangular tube (e.g., a metallic tube) having a same or uniform cross-sectional area or shape along its length. The linear valve manifold 215 can have a plurality of holes or openings 280 on a top surface 217 as shown in a diagram 200b in FIG. 2B. The number of holes 280 shown (e.g., 7 holes) is provided by way of illustration and the number can vary, that is, the number of holes can be greater or smaller than the number shown in the diagram 200b. Moreover, the holes 280 can be equally spaced or can be spaced at different distances (e.g., the distance between any two adjacent or consecutive holes 280 is different). While the holes 280 may typically be of the same size, the size of the holes 280 can also vary. For example, the spacing of the holes 280 and/or the size of the holes 280 can vary (e.g., increase and/or decrease) in a direction from the proximal end of the linear valve manifold 215 to the distal end of the linear valve manifold 215. The variation in the spacing and/or the size can be linear or can be non-linear.

Within the linear valve manifold 215 there is a leadscrew 225 that extends the length of the linear valve manifold 215 and is held in place on both ends by bearings 240a and 240b outside the linear valve manifold 215. The leadscrew 225 can be positioned at or near the center of the cross-sectional area of the linear valve manifold 215. The motor 230, which can be an indexing motor, rotates or turns a shaft 232 that is mechanically coupled to both the motor 230 and the motor coupling 235. The motor coupling 235 is also mechanically coupled to the leadscrew 225 and the rotation of the shaft 232 by the motor 230 causes the leadscrew 225 to also rotate or turn. The rotation of the leadscrew 225 is converted into a horizontal translation or movement of a piston 220 (e.g., left or right movement along the plane of FIG. 2A) within the linear valve manifold 215. That is, the leadscrew 225 converts a turning motion of the motor 230 into linear motion of the piston 220. This linear movement allows the positioning of the piston 220 within the linear valve manifold 215 to be changed in order to select which one(s) of the holes 280 is to have a path to the vacuum source 270 through the distribution manifold 260.

The top plate 110 described above with respect to FIG. 1 can be positioned over the top surface 217 of the linear valve manifold 215 as shown in the diagram 200a. In other examples, not shown, the vacuum chuck 170 with the top plate 110 (e.g., a vacuum table as described in FIG. 1) can be positioned over the top surface 217 of the linear valve manifold 215. In either case, at least a subset of the holes 120 of the top plate 110 (or at least a subset of both the holes 120 of the top plate 110 and the holes 180 of the vacuum chuck 170) are aligned with the holes 280 of the linear valve manifold 215.

FIG. 2C shows a diagram 200c in which the workpiece 150 has been positioned over the top plate 110 for handling or processing. In order to allow vacuum to be applied below the workpiece 150 to keep it in place, the piston 220 may be moved from, for example, a first, initial, or default position A (shown as dashed lines). When the piston 220 is in position A, the piston 220 blocks a path from the holes 280 to the distribution manifold 260 such that there is no vacuum applied to any of the holes 280 and, consequently, there is no vacuum leakage. In this case, all of the holes 280 are considered to be “closed.”

The piston 220 may then be moved from the initial position A (or from any other initial position) by having the motor 230 through the motor coupling 235 turn the leadscrew 225 in one rotational direction (e.g., clockwise or counter-clockwise depending on the thread angle of the leadscrew 225). In the example shown in FIG. 2C, the piston 220 is moved from the position A to a position B such that each of the holes 280 that are below the workpiece 150 have an open path to the vacuum source 270 through the distribution manifold 260. That is, each of these holes 280 with a path to vacuum are considered to be “open” holes. In this way, vacuum is applied below the workpiece 150 and a force is exerted on the workpiece 150 to hold it in place against the top plate 110. When processing of the workpiece 150 is completed and the workpiece 150 is to be removed, the piston 220 may be moved back to the position A by having the motor 230 through the motor coupling 235 turn the leadscrew 225 in the opposite rotational direction. This results in the closing of any previously opened holes to avoid any vacuum leaks.

A controller 250, which is shown in FIGS. 2A and 2C, can be used to generate signals that control motor 230 to automate the linear movement of the piston 220 for selecting the appropriate holes 280 on which to apply vacuum to hold down the workpiece 150. The controller 250 can include a processor 255 and a memory 257 that stores instructions used by the processor 255 to control the motor 230.

In general, the solution provided by this disclosure as shown by the examples in FIGS. 2A-2C is built around a linear valve/manifold. The valve mechanism consists of a piston (e.g., the piston 220) driven by a leadscrew (e.g., the leadscrew 225) and the body of the valve (e.g., the linear vacuum valve 210) is the manifold itself (e.g., linear valve manifold 215). As the piston advances along and within the manifold the path to the source vacuum becomes open. This approach allows for automatic configuration of a build area on which to place workpieces by arranging or aligning multiple valves next to each other. In an example, when the build area is a square or rectangular area configured by having multiple valves (e.g., multiple linear vacuum valves 210) positioned adjacent to each other to form an array of holes 280 on which to place the top plate 110, and where each valve corresponds to a column in the build area, then only one motor (e.g., the motor 230) is needed for each column of the build area. This is in contrast with the example described above where a large matrix of valves and associated manifolds would be required.

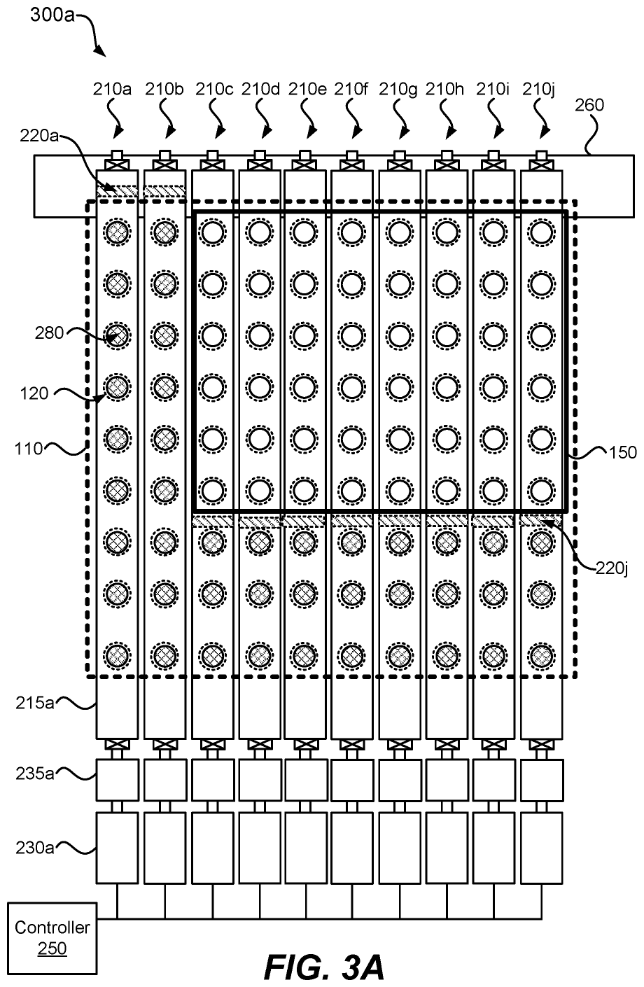

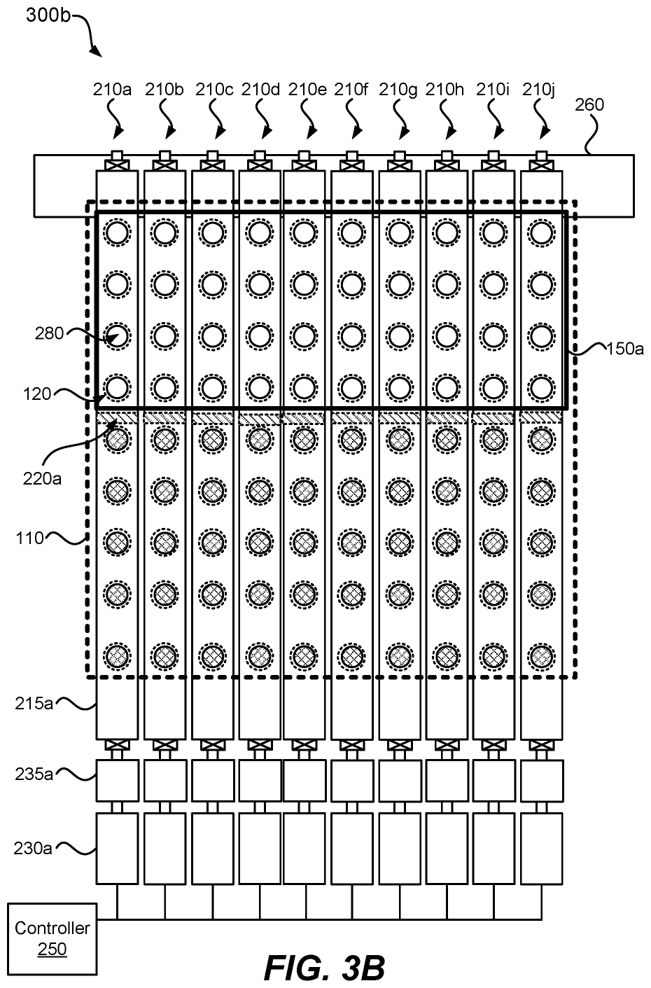

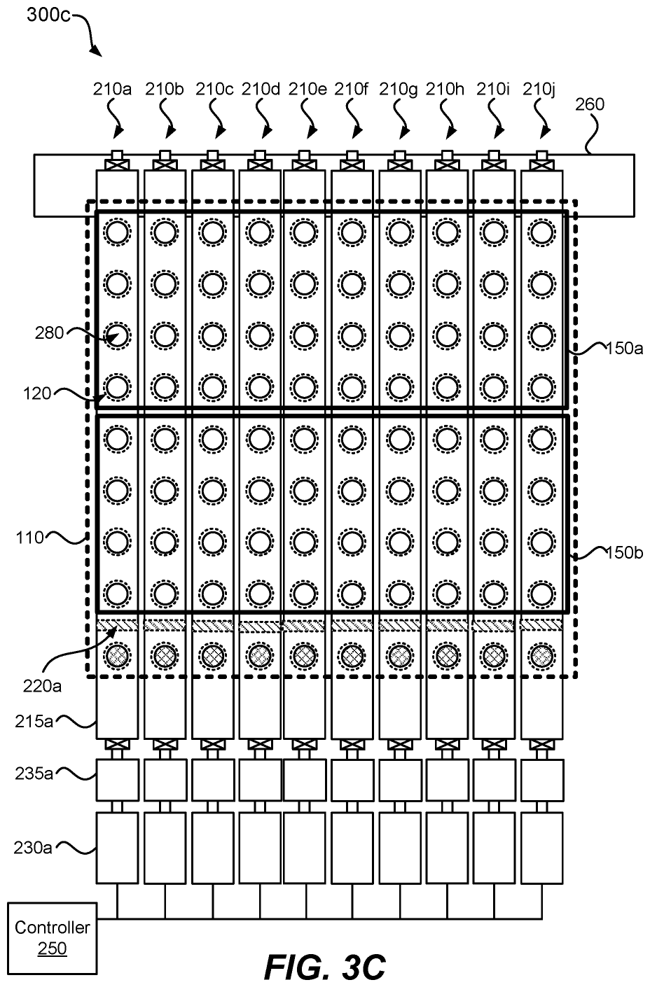

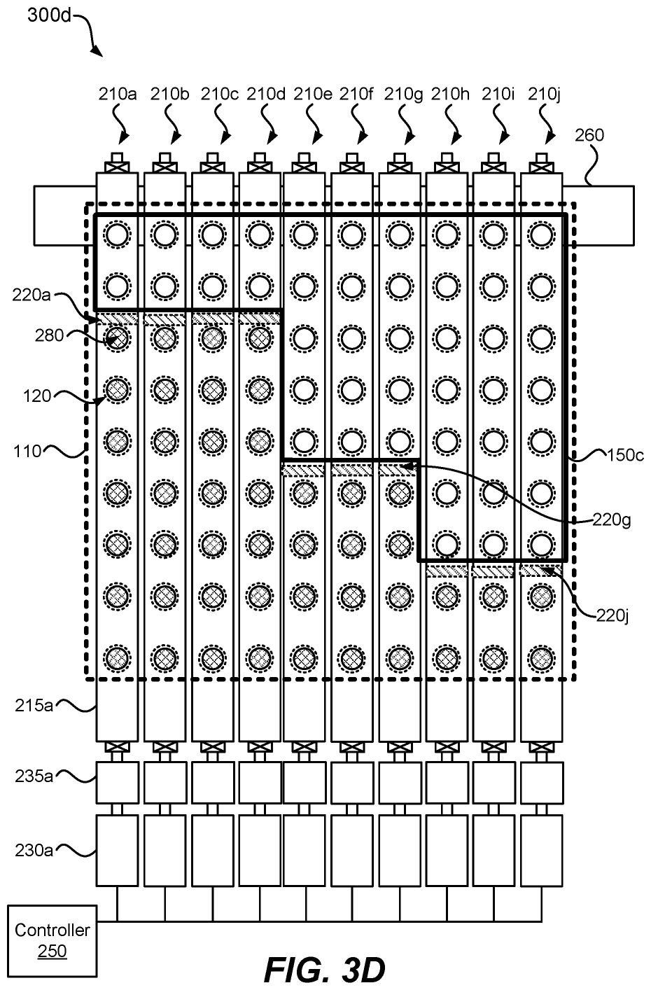

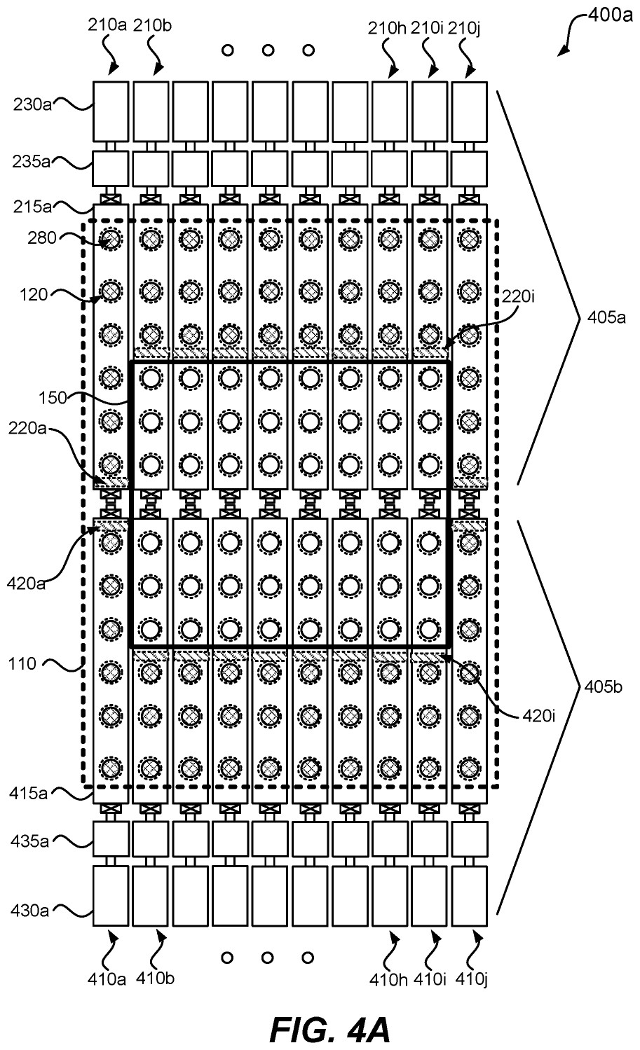

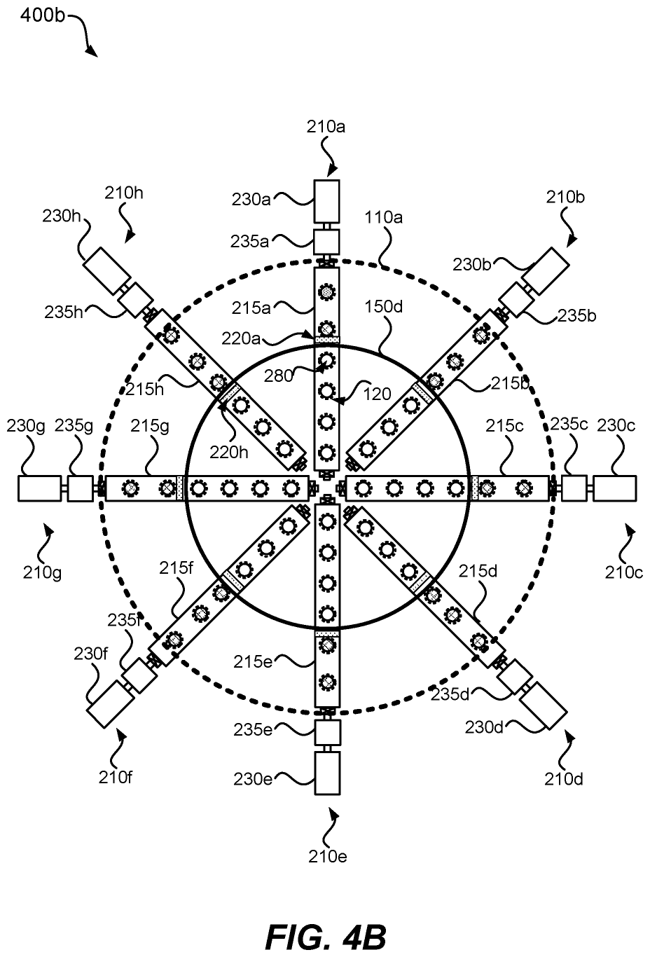

Different configurations of build areas can be implemented using arrays of linear vacuum valves 210 as described above. Non-limiting examples of such configurations are described below in more detail in connection with FIGS. 3A-4B.

In FIG. 3A, a diagram 300a is shown that illustrates a top view of an array of linear vacuum valves 210 used to provide a build area on which to hold down different types of workpieces. In this example, there are ten (10) linear vacuum valves 210 arranged next to or adjacent to each other forming a 1×10 array of linear vacuum valves 210. The linear vacuum valves 210 include linear vacuum valves 210a, . . . , 210j, each of which is coupled to the distribution manifold 260 (although not shown the distribution manifold 260 is coupled to the vacuum source 270). Each of the linear vacuum valves 210 has nine (9) holes or openings 280 forming a 9×10 array of holes 280 for the build area. In other examples, the number of linear vacuum valves 210 can be greater or smaller and/or the number of holes 280 in each of the linear vacuum valves 210 can be greater or smaller. As such, the size of the array of linear vacuum valves 210 can be 1×N, where N is an integer number and corresponds to the number of linear vacuum valves or columns of the array, and where N is greater than 1. Similarly, the size of the array of holes 280 can be P×N, where P is an integer number and corresponds to the number of holes 280 in each linear vacuum valve, and where P is greater than 1.

The linear vacuum valves 210a, . . . , 210j may be similar to each other and, therefore, the linear vacuum valve 210a can be representative of the other linear vacuum valves 210 in the array. Accordingly, and consistent with the description of FIGS. 2A-2C above, the linear vacuum valve 210a (and therefore all other linear vacuum valves 210 in FIG. 3A) may include a linear valve manifold 215a within which there is a piston 220a. The linear vacuum valve 210a may also include a motor 230a and a motor coupling 235a, where the motor 230a is controlled by the controller 250 to move the piston 220a along the length of the linear valve manifold 215a in order to open (e.g., create or open a path to a source of vacuum) one or more of the holes 280 in the linear valve manifold 215a while any remaining holes in the linear valve manifold 215a are maintained or remain closed (e.g., a path to a source of vacuum is blocked).

In the example in FIG. 3A, the top plate 110 (shown as see through and with its perimeter outline as a thick, dashed line) is positioned over the array of linear vacuum valves 210 such that each of the holes 280 (solid circles) in the array of holes 280 coincides or is aligned with a corresponding hole 120 (dashed circle) of the multiple holes 120 in the top plate 110. Also shown in FIG. 3A is a top view of the workpiece 150 (shown as see through and with its perimeter outline as a thick, solid line).

As illustrated in FIG. 3A, the workpiece 150 may not cover the entire build area of the top plate 110 or of the array of linear vacuum valves 210. Accordingly, the controller 250 may be used to move or adjust the piston 220 in one or more of the linear vacuum valves 210a, . . . , 210j such that the holes 280 that are below the workpiece 150 are opened to apply vacuum for exerting a force that holds the workpiece 150 down for handling/processing. The other holes 280, that is, those not positioned below the workpiece 150, are initially closed and are maintained closed.

In this example, the holes 280 in the linear vacuum valves 210a and 210b are all maintained closed (cross-hatch pattern), while for each of the linear vacuum valves 210c, . . . , 210j, six (6) of the holes 280 are opened (white pattern) and three (3) of the holes 280 are maintained closed (cross-hatch pattern). For this to happen, the controller 250 controls the pistons 220 such that the piston 220a, as well as the piston for the linear vacuum valve 210b, are maintained at an initial or default position where all of the holes 280 are closed, while the piston 220j, as well as the pistons for the linear vacuum valves 210c, . . . , 210i, are moved to a position different from the initial or default position to open six (6) holes 280 in each of the linear vacuum valves 210c, . . . , 210j. As described above, opening a hole 280 involves providing a path to vacuum, where the vacuum is applied through the hole 280 as well as through the respective hole 120 in the top plate 110 to exert or produce a force to hold down the workpiece 150. Similarly, maintaining a hole or opening 280 closed involves blocking or closing a path to vacuum such that no vacuum is applied through the hole 280 and, therefore, no vacuum leakage occurs through that hole. Once processing of the workpiece 150 is completed, the controller 250 may move any piston not in the initial or default position back to that position.

FIG. 3B shows a diagram 300b with the same array of linear vacuum valves 210 as shown in FIG. 3A. In this example, however, a workpiece 150a having a different shape and/or size than that of the workpiece 150 in FIG. 3A is to be processed requiring different holes 280 to be opened to hold down the workpiece 150a. That is, the subset of the holes 280 in the 9×10 array of holes 280 through which vacuum needs to be applied to hold the workpiece 150a in place is different than the subset of holes 280 used to hold the workpiece 150 in place in FIG. 3A. For example, for each of the linear vacuum valves 210a, . . . , 210j, four (4) of the holes 280 are opened (white pattern) and five (5) of the holes 280 are maintained closed (cross-hatch pattern). For this to happen, the controller 250 controls the pistons 220 such that the piston 220a, as well as the piston for all of the other linear vacuum valves 210, are moved to a same position different from an initial or default position to open four (4) holes 280 in each of the linear vacuum valves 210a, . . . , 210j. Once processing of the workpiece 150a is completed, the controller 250 may move the pistons back to the initial or default position in which all of the holes 280 are closed (e.g., path to vacuum for the holes 280 is blocked or closed by the piston).

FIG. 3C shows a diagram 300c with the same array of linear vacuum valves 210 as shown in FIGS. 3A and 3B. In this example, however, there are two workpieces to be processed, the workpiece 150a and a second workpiece 150b, which have the same shape and size, but which have a different shape and/or size than that of the workpiece 150 in FIG. 3A. In this case, the build area provided by the array of linear vacuum valves 210 and the top plate 110 is sufficiently large to handle multiple workpieces at the same time. The workpieces can be placed on the build area at the same time or sequentially. Although only two workpieces are shown, it is to be understood that the same or similar implementation can be configured to hold or process more than two workpieces. In some applications, such as in the assembly of photovoltaic cells into photovoltaic modules, the build area may need to be configured to handle a large number of workpieces.

Because the area covered by the workpieces 150a and 150b in FIG. 3C (which are positioned next to each other) is different than the area covered by the workpiece 150 in FIG. 3A, the subset of the holes 280 in the 9×10 array of holes 280 through which vacuum needs to be applied to hold the workpieces 150a and 150b in place is different than the subset of holes 280 used to hold the workpiece 150 in place in FIG. 3A. For example, for each of the linear vacuum valves 210a, . . . , 210j, eight (8) of the holes 280 are opened (white pattern) and one (1) of the holes 280 is maintained closed (cross-hatch pattern). For this to happen, the controller 250 controls the pistons 220 such that the piston 220a, as well as the piston for all of the other linear vacuum valves 210, are moved to a same position different from an initial or default position to open eight (8) holes 280 in each of the linear vacuum valves 210a, . . . , 210j. As shown in FIG. 3C, the first four (4) of the eight (8) holes 280 are for the workpiece 150a and the second four (4) of the eight (8) holes 280 are for the workpiece 150b. Once processing of the workpieces 150a and 150b is completed, the controller 250 may move the pistons back to the initial or default position in which all of the holes 280 are closed (e.g., path to vacuum for the holes 280 is blocked or closed by the piston).

With respect to FIGS. 3B and 3C, it is to be understood that there may be instances in which a workpiece (e.g., the workpiece 150a) is initially positioned for handling (as in FIG. 3B) and one or more additional workpieces (e.g., the workpiece 150b) are subsequently positioned for handling (as in FIG. 3C). In such instances, a first set of holes 280 may be opened to hold down the first workpiece and additional holes 280 may be opened subsequently to hold down the one or more additional workpieces.

FIG. 3D shows a diagram 300d with the same array of linear vacuum valves 210 as shown in FIGS. 3A-3C. In this example, however, a workpiece 150c having different shape and/or size than that of the workpiece 150 in FIG. 3A is to be processed. For example, the workpiece 150 is a rectangular piece while the workpiece 150c has a polygonal shape that is neither square nor rectangular. Accordingly, the subset of the holes 280 in the 9×10 array of holes 280 through which vacuum is to be applied to hold the workpiece 150c in place is different than the subset of holes 280 used to hold the workpiece 150 in place in FIG. 3A. For example, for each of the linear vacuum valves 210a, . . . , 210d, two (2) of the holes 280 are opened (white pattern) and seven (7) of the holes 280 are maintained closed (cross-hatch pattern), for each of the linear vacuum valves 210e, . . . , 210g, five (5) of the holes 280 are opened and four (4) of the holes 280 are maintained closed, and for each of the linear vacuum valves 210h, . . . , 210j, seven (7) of the holes 280 are opened and two (2) of the holes 280 are maintained closed. For this to happen, the controller 250 controls the pistons 220 such that the piston 220a, as well as the pistons for the linear vacuum valves 210b, . . . 210d, are moved to a same position different from an initial or default position to open two (2) holes 280 in each of the linear vacuum valves 210a, . . . , 210d. Moreover, the controller 250 controls the pistons 220 such that the piston 220g, as well as the pistons for the linear vacuum valves 210e and 210f, are moved to a same position different from an initial or default position to open five (5) holes 280 in each of the linear vacuum valves 210e, . . . , 210g. The controller 250 also controls the pistons 220 such that the piston 220j, as well as the pistons for the linear vacuum valves 210h and 210i, are moved to a same position different from an initial or default position to open seven (7) holes 280 in each of the linear vacuum valves 210h, . . . , 210j. Once processing of the workpiece 150c is completed, the controller 250 may move the pistons back to the initial or default position in which all of the holes 280 are closed (e.g., path to vacuum for the holes 280 is blocked or closed by the piston).

In addition to the one-dimensional arrays of linear vacuum valves 210 described in FIGS. 3A-3D, implementations of other types of arrays may also be possible depending on the types of workpieces being processed and the processing operations themselves. FIGS. 4A and 4B below provide examples of additional implementations.

FIG. 4A shows a diagram 400a that illustrates a top view of another arrangement of multiple linear vacuum used to provide a build area on which to hold down different types of workpieces. In contrast to the examples in FIGS. 3A-3D, this arrangement or configuration implements a two-dimensional array of linear vacuum valves based on two side-by-side one-dimensional arrays of linear vacuum valves to cover a larger build area. This approach may allow for the processing or handling of larger workpieces and/or more workpieces at the same time. Moreover, this approach may allow to process or handle workpieces at the center of the build area.

In the example in FIG. 4A there is a first array 405a of linear vacuum valves 210a, . . . , 210j, and a second array 405b of linear vacuum valves 410a, . . . , 410j adjacent to each other, where each of the linear vacuum valves is coupled to a vacuum source through a distribution manifold (not shown). The first array 405a includes ten (10) linear vacuum valves 210 arranged next to each other forming a 1×10 array of linear vacuum valves 210, and the second array 405b includes ten (10) linear vacuum valves 410 arranged next to each other forming a 1×10 array of linear vacuum valves 410. These two arrays together form an overall 2×10 array of linear vacuum valves 210 and 410.

Each of the linear vacuum valves 210, 410 has six (6) holes or openings 280 forming a (2×6)×10 or 12×10 array of holes 280. In other examples, the number of linear vacuum valves 210, 410 can be greater or smaller and/or the number of holes 280 in each of the linear vacuum valves 210, 410 can be greater or smaller. As such, the size of the overall array of linear vacuum valves 210 and 410, can be 2×N, where N is an integer number, and where N is greater than 1. Similarly, the size of the array of holes 280 can be (2×P)×N, where P is an integer number and corresponds to the number of holes 280 in each linear vacuum valve, and where P is greater than 1.

The linear vacuum valves 210a, . . . , 210j may be similar to each other and, therefore, the linear vacuum valve 210a can be representative of the other linear vacuum valves 210 in the array 405a, and may include the linear valve manifold 215a within which there is the piston 220a, as well as the motor 230a and the motor coupling 235a. The linear vacuum valves 410a, . . . , 410j may be similar to each other and, therefore, the linear vacuum valve 410a can be representative of the other linear vacuum valves 410 in the array 405b, and may include a linear valve manifold 415a within which there is a piston 420a, as well as a motor 430a and a motor coupling 435a. The motors 230, 430 may be controlled by the controller 250 (not shown) to move the pistons 220, 420 along the length of the linear valve manifolds 215, 415 in order to open (e.g., create or open a path to a source of vacuum) one or more of the holes 280 while any remaining holes are maintained closed (e.g., a path to a source of vacuum is blocked). While a single controller 250 may be used to control the positioning of pistons within the linear valve manifolds 215, 415 in the arrays 405a and 405b, more than one controller may also be used, for example, one controller may be used to control the positioning of the pistons in the linear valve manifolds 215 in the array 405a and another controller may be used to control the positioning of the pistons in the linear valve manifolds 415 in the array 405b.

In the example in FIG. 4A, the top plate 110 (shown as see through and with its perimeter outline as a thick, dashed line) is positioned over the overall array of linear vacuum valves 210, 410 such that each of the holes 280 (solid circles) in the array of holes 280 coincides or is aligned with a corresponding hole 120 (dashed circle) of the multiple holes 120 in the top plate 110.

Also shown in FIG. 4A is a top view of the workpiece 150 (shown as see through and with its perimeter outline as a thick, solid line). The workpiece 150 may not cover the entire build area of the top plate 110 or of the overall array of linear vacuum valves 210 and 410. In this example, the workpiece 150 overlaps part of the array 405a and part of the array 405b such that holes 280 in both the array 405a and the array 405b may need to be opened to hold down the workpiece 150. Accordingly, one or more controllers (e.g., the controller 250) may be used to move or adjust the pistons in one or more of the linear vacuum valves 210a, . . . , 210j and the pistons in one or more of the linear vacuum valves 410a, . . . , 410j such that the holes 280 that are below the workpiece 150 are opened to apply vacuum for exerting a force that holds the workpiece 150 down for handling/processing. The other holes 280, that is, those holes 280 not positioned below the workpiece 150, are maintained closed.

In this example, the holes 280 in the linear vacuum valves 210a and 210j are all maintained closed (cross-hatch pattern), while for each of the linear vacuum valves 210b, . . . , 210j, three (3) of the holes 280 are opened (white pattern) and three (3) of the holes 280 are maintained closed (cross-hatch pattern). For this to happen, the piston 220a, as well as the piston for the linear vacuum valve 210j, are maintained at an initial or default position where all of the holes 280 are closed, while the piston 220i, as well as the pistons for the linear vacuum valves 210b, . . . , 210h, are moved to a position different from the initial or default position to open three (3) holes 280 in each of the linear vacuum valves 210b, . . . , 210i.

Similarly, the holes 280 in the linear vacuum valves 410a and 410j are all maintained closed (cross-hatch pattern), while for each of the linear vacuum valves 410b, . . . , 410j, three (3) of the holes 280 are opened (white pattern) and three (3) of the holes 280 are maintained closed (cross-hatch pattern). For this to happen, the piston 420a, as well as the piston for the linear vacuum valve 410j, are maintained at an initial or default position where all of the holes 280 are closed, while the piston 420i, as well as the pistons for the linear vacuum valves 410b, . . . , 410h, are moved to a position different from the initial or default position to open three (3) holes 280 in each of the linear vacuum valves 410b, . . . , 410i.

Once processing of the workpiece 150 in FIG. 4A is completed, any piston not in the initial or default position may be moved back to that position.

FIG. 4B shows a diagram 400b that illustrates a top view of yet another arrangement of multiple linear vacuum valves. In contrast to the examples in FIGS. 3A-3D and 4A, this arrangement or configuration implements a radial array of linear vacuum valves to cover a circular build area. This approach may allow for the processing or handling of round or round-like workpieces of different sizes, for example, although round or round-like workpieces may also be processed or handled in the configurations described above.

In this example, there are eight (8) linear vacuum valves 210 arranged in a radial configuration at or about 45 degrees from each other. In other examples more or fewer linear vacuum valves 210 may be used and as a result the angular separation may change. The linear vacuum valves 210 include linear vacuum valves 210a, . . . , 210h, where each is coupled to a distribution manifold further coupled to a vacuum source (not shown). Each of the linear vacuum valves 210 in this example has six (6) holes or openings 280 forming a radial array of holes 280. Because of the radial configuration, it may be possible to use linear vacuum valves having different lengths and/or different number of holes at different angles in order to produce a desired separation between the holes 280 in the radial array of holes 280.

The linear vacuum valve 210a may include the linear valve manifold 215a within which there is a piston (e.g., piston 220). The linear vacuum valve 210a may also include the motor 230a and the motor coupling 235a, where the motor 230a is controlled by a controller (not shown) to move a piston along the length of the linear valve manifold 215a in order to open (e.g., create or open a path to a source of vacuum) one or more of the holes 280 in the linear valve manifold 215a while any remaining holes in the linear valve manifold 215a are maintained closed (e.g., a path to a source of vacuum is blocked). Similar to the linear vacuum valve 210a, the linear vacuum valves 210b, . . . , 210h, respectively include linear valve manifolds 215b, 215h, motors 230b, . . . , 230h, and motor couplings 235b, 235h.

A circular or round top plate 110a (shown as see through and with its perimeter outline as a thick, dashed line) is positioned over the array of linear vacuum valves 210 such that each of the holes 280 (solid circles) in the array of holes 280 coincides or is aligned with a corresponding hole 120 (dashed circle) of the multiple holes 120 in the top plate 110a. Also shown in FIG. 4B is a top view a circular or round workpiece 150d (shown as see through with its perimeter outline shown as a thick, solid line). In some cases, the workpiece 150d need not be round or circular, or need not be entirely round or circular.

The workpiece 150d may not cover the entire build area of the top plate 110a or of the array of linear vacuum valves 210. Accordingly, a controller (e.g., the controller 250) may be used to move or adjust the piston in one or more of the linear vacuum valves 210a, . . . , 210h such that the holes 280 that are below the workpiece 150d are opened to apply vacuum for exerting a force that holds the workpiece 150d down and in place for handling/processing. The other holes 280, that is, those not positioned below the workpiece 150d, are maintained closed.

In this example, for each of the linear vacuum valves 210a, 210c, 210e, and 210g, four (4) of the holes 280 are opened (white pattern) and two (2) of the holes 280 are maintained closed (cross-hatch pattern). For each of the linear vacuum valves 210b, 210d, 210f, and 210h, three (3) of the holes 280 are opened (white pattern) and three (3) of the holes 280 are maintained closed (cross-hatch pattern). A controller may control the pistons such that the pistons are moved to a position different from the initial or default position to open the appropriate holes 280. For example, a piston 220a for the linear vacuum valve 210a may be moved to open four holes 280 while keeping the remaining two holes closed. A similar approach may be taken for the pistons in the linear vacuum valves 210c, 210e, and 210g. Moreover, a piston 220h for the linear vacuum valve 210h may be moved to open three holes 280 while keeping the remaining three holes closed. A similar approach may be taken for the pistons in the linear vacuum valves 210b, 210d, and 210f. Once processing of the workpiece 150d is completed, the controller may move the pistons back to their initial or default position.

The various implementations and configurations of systems including arrays of linear vacuum valves described above are provided by way of illustration and not of limitation. In one general implementation, for example, a system for holding workpieces in place during processing can include a distribution manifold (e.g., the distribution manifold 260) coupled to a vacuum source (e.g., the vacuum source 270). The system may also include multiple linear valves (e.g., the linear vacuum valves 210, the linear vacuum valves 410 in FIGS. 2A-4B) coupled to the distribution manifold, each linear valve having a manifold (e.g., the linear valve manifold 215) with multiple openings (e.g., holes 280) and being adjustable to select one or more of the multiple openings to have a path to the vacuum source through the distribution manifold for providing a vacuum to hold one or more of the workpieces in place. The workpieces may include optoelectronic devices such as photovoltaic devices, for example.

In an aspect of this system, the multiple linear valves are positioned adjacent to each other (see e.g., FIGS. 3A-4A) and under a vacuum chuck or a vacuum table (e.g., vacuum table described in FIG. 1) on which the workpieces are held in place by vacuum provided by the vacuum source through the one or more of the multiple openings in each of the linear valves that have a path to the vacuum source. The multiple openings of the multiple linear valves are collocated (e.g., aligned) with multiple openings in the vacuum chuck or the vacuum table (e.g., the holes 120 and/or the holes 180).

In another aspect of the system, each linear valve includes a leadscrew (e.g., the leadscrew 225) and a piston (e.g., the piston 220) both disposed inside the manifold, the piston being moved along a length of the manifold by rotation of the leadscrew to select the one or more of the multiple openings in the manifold when the linear valve is adjusted. A cross-sectional shape or area of the manifold is configured to match a shape or area of the piston to prevent rotation of the piston with respect to the leadscrew. The system may include a motor (e.g., the motor 235) associated with each linear valve and configured to adjust the linear valve by driving the rotation of the leadscrew and thereby moving the piston along the length of the manifold. In one example, the motor can be an indexable motor. The system may also include a motor coupling (e.g., the motor coupling 235) that mechanically couples the motor and the leadscrew for the associated linear valve.

In another aspect of the system, each linear valve is configured to be have the piston moved by the rotation of the leadscrew to a first position within the manifold such that only a first subset of the multiple openings in the manifold has a path to the vacuum source, and subsequently to a second position within the manifold such that only a second subset of the multiple openings in the manifold has a path to the vacuum source, and the first subset of the multiple openings is different from the second subset of the multiple openings. In some instances, the first position is an initial or default position (see e.g., the position A in FIG. 2C) such that the first subset does not include any of the multiple openings in the manifold has a path to the vacuum source (all the openings are closed to vacuum), and the second position (see e.g., the position B in FIG. 2C) includes at least one of the multiple openings in the manifold having a path to the vacuum source. A number of openings in the first subset of the multiple openings is different from a number of openings in the second subset of multiple openings. Moreover, the openings in the first subset of the multiple openings are contiguous (e.g., consecutive openings or holes in the manifold) and the openings in the second subset of the multiple openings are also contiguous.

In another aspect of the system, the manifold is an elongated member having a proximal end and a distal end, and the distribution manifold is also an elongated member positioned across the multiple linear valves and coupled to the proximal end of the manifold of each linear valve to provide a path to the vacuum source. As mentioned above, the system may include a motor (e.g., the motor 230) for each linear valve, where the motor is coupled to the distal end of the manifold of the linear valve. The manifold in each linear valve may have a square cylindrical shape or a rectangular cylindrical shape, however, other types of cylindrical shapes may also be used.

In another general implementation, for example, a system for holding workpieces in place during processing can include a vacuum holder having a first array of openings (e.g., the holes 120, the holes 180), a system of linear valves (e.g., the arrays of linear vacuum valves in FIGS. 2A-4B) positioned below the vacuum holder and having a second array of openings (e.g., the holes 280) that aligns with the first array of openings. The vacuum holder can be a vacuum table, a vacuum chuck, and/or a top plate, for example (e.g., the vacuum table described in FIG. 1, the vacuum chuck 170, the top plate 110). The system may also include a vacuum source (e.g., the vacuum source 270) to provide a vacuum for holding one or more of the workpieces on the vacuum holder. In an example, the workpieces include photovoltaic devices.

The system of linear valves includes multiple linear valves and a distribution manifold (e.g., the distribution manifold 260) coupled to the vacuum source and to the multiple linear valves, each linear valve including a manifold (e.g., the linear valve manifold 215) with multiple openings (e.g., the holes 280), each linear valve being adjustable (e.g., automatically adjustable) to select one or more of the multiple openings in the manifold to have a path to the vacuum source through the distribution manifold, and the second array of openings including the multiple openings of the manifolds of the multiple linear valves.

The multiple linear valves are configured to be individually adjusted to select a subset of the second array of openings for providing the vacuum, where the subset of the second array openings is selected based on a size of the one or more of the workpieces to be held on the vacuum holder.

The multiple linear valves are configured to be individually adjusted to select a first subset of the second array of openings for providing the vacuum to hold one of the workpieces and to subsequently select a second subset of the second array of openings for providing the vacuum to hold an additional one of the workpieces.

In one aspect of the system, each linear valve includes a leadscrew (e.g., the leadscrew 225) and a piston (e.g., the piston 220) both disposed inside the manifold, where the piston can be moved along a length of the manifold by rotation of the leadscrew to select the one or more of the multiple openings in the manifold when the linear valve is adjusted. The system can further include a motor (e.g., the motor 230) associated with each linear valve and configured to adjust the linear valve by driving the rotation of the leadscrew and thereby moving the piston along the length of the manifold. In one example, the motor is an indexable motor.

In another aspect of the system, the multiple linear valves are adjacently positioned such that the multiple openings in their respective manifolds are arranged to form the second array of openings (see e.g., the array of holes 280 in FIGS. 2A-4B).

In yet another aspect of the system, the second array of openings is aligned with the first array of openings such that vacuum applied through one of the openings in the second array of openings is applied through a corresponding opening in the first array of openings.

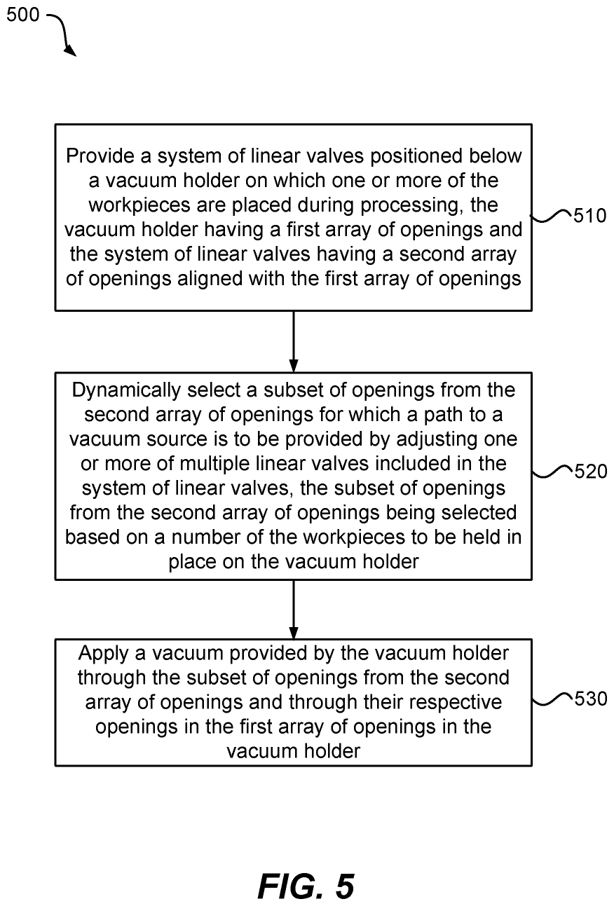

FIG. 5 shows a flow chart that illustrates a method 500 for holding workpieces in place during processing, wherein the workpieces can include, but need not be limited to, optoelectronic devices such as photovoltaic devices, for example.

At block 510, the method 500 includes providing a system of linear valves positioned below a vacuum holder on which one or more of the workpieces are placed during processing, the vacuum holder having a first array of openings and the system of linear valves having a second array of openings aligned with the first array of openings.

At block 520, the method 500 includes dynamically selecting (e.g., through the controller 250) a subset of openings from the second array of openings for which a path to a vacuum source is to be provided by adjusting one or more of multiple linear valves included in the system of linear valves, the subset of openings from the second array of openings being selected based on a number of the workpieces to be held in place on the vacuum holder.

At block 530, the method 500 includes applying a vacuum provided by the vacuum holder through the subset of openings from the second array of openings and through their respective openings in the first array of openings in the vacuum holder.

In another aspect of the method 500, adjusting the one or more of multiple linear valves included in the system of linear valves includes adjusting, for at least one of the linear valves, a position of a piston within a manifold of each linear valve to enable one or more openings in the manifold of that linear valve to be part of the subset of openings and have a path to the vacuum source while remaining openings in the manifold of that linear valve are isolated from the vacuum source. Moreover, adjusting the position of the piston within the manifold includes rotating or turning a leadscrew to move the piston along the length of the manifold to the position, the leadscrew being rotated by running a motor coupled to the leadscrew (e.g., the motor 230 mechanically coupled to the leadscrew 225 via the motor coupling 235).

In another aspect of the method 500, dynamically selecting the subset of openings from the second array of openings for which a path to the vacuum source is to be provided includes increasing a number of openings selected for the subset of openings from the second array of openings when additional workpieces are to held in place for processing.

In another aspect of the method 500, the method 500 may include disabling or removing the application of the vacuum when the processing is completed and returning the multiple linear valves included in the system of linear valves to a default position (e.g., returning the pistons to a default position in which the openings or holes of the linear valve are all closed or without a path to vacuum).

Although the present disclosure has been provided in accordance with the implementations shown, one of ordinary skill in the art will readily recognize that there could be variations to the embodiments and those variations would be within the scope of the present disclosure. For example, different configurations, sizes, components, and/or devices can be contemplated that are consistent with the techniques described in this disclosure. Accordingly, many modifications may be made by one of ordinary skill in the art without departing from the scope of the appended claims.

What is claimed is:

1. A system for holding workpieces in place during processing, comprising:
a distribution manifold coupled to a vacuum source; and
multiple linear valves coupled to the distribution manifold, each linear valve having a manifold with multiple openings and being adjustable to select one or more of the multiple openings to have a path to the vacuum source through the distribution manifold for providing a vacuum to hold one or more of the workpieces in place.

2. The system of claim 1, wherein the multiple linear valves are positioned adjacent to each other and under a vacuum chuck or a vacuum table on which the workpieces are held in place by vacuum provided by the vacuum source through the one or more of the multiple openings in each of the linear valves that have a path to the vacuum source.

3. The system of claim 2, wherein the multiple openings of the multiple linear valves are collocated with multiple openings in the vacuum chuck or the vacuum table.

4. The system of claim 1, wherein each linear valve includes a leadscrew and a piston both disposed inside the manifold, the piston being moved along a length of the manifold by rotation of the leadscrew to select the one or more of the multiple openings in the manifold when the linear valve is adjusted.

5. The system of claim 4, further comprising a motor associated with each linear valve and configured to adjust the linear valve by driving the rotation of the leadscrew and thereby moving the piston along the length of the manifold.

6. The system of claim 5, wherein the motor is an indexable motor.

7. The system of claim 4, wherein a cross-sectional shape of the manifold is configured to match a shape of the piston to prevent rotation of the piston with respect to the leadscrew.

8. The system of claim 4, further comprising a motor coupling that mechanically couples the motor and the leadscrew for the associated linear valve.

9. The system of claim 4, wherein:
each linear valve is configured to be have the piston moved by the rotation of the leadscrew to a first position within the manifold such that only a first subset of the multiple openings in the manifold has a path to the vacuum source, and subsequently to a second position within the manifold such that only a second subset of the multiple openings in the manifold has a path to the vacuum source, and
the first subset of the multiple openings is different from the second subset of the multiple openings.

10. The system of claim 9, wherein a number of openings in the first subset of the multiple openings is different from a number of openings in the second subset of multiple openings.

11. The system of claim 9, wherein the openings in the first subset of the multiple openings are contiguous and the openings in the second subset of the multiple openings are contiguous.

12. The system of claim 1, wherein:
the manifold is an elongated member having a proximal end and a distal end, and
the distribution manifold is also an elongated member positioned across the multiple linear valves and coupled to the proximal end of the manifold of each linear valve to provide a path to the vacuum source.

13. The system of claim 12, further comprising a motor associated with each linear valve, wherein the motor is coupled to the distal end of the manifold of the linear valve.

14. The system of claim 1, wherein the manifold in each linear valve has a square cylindrical shape.

15. The system of claim 1, wherein the workpieces include optoelectronic devices.

16. The system of claim 15, wherein the optoelectronic devices include photovoltaic devices.

17. A system for holding workpieces in place during processing, comprising:
a vacuum holder having a first array of openings;
a system of linear valves positioned below the vacuum holder and having a second array of openings that aligns with the first array of openings; and
a vacuum source to provide a vacuum for holding one or more of the workpieces on the vacuum holder, wherein:
the system of linear valves includes multiple linear valves and a distribution manifold coupled to the vacuum source and to the multiple linear valves, each linear valve including a manifold with multiple openings, each linear valve being adjustable to select one or more of the multiple openings in the manifold to have a path to the vacuum source through the distribution manifold, and the second array of openings including the multiple openings of the manifolds of the multiple linear valves.

18. The system of claim 17, wherein the multiple linear valves are configured to be individually adjusted to select a subset of the second array of openings for providing the vacuum.

19. The system of claim 17, wherein the subset of the second array openings is selected based on a size of the one or more of the workpieces to be held on the vacuum holder.

20. The system of claim 17, wherein the multiple linear valves are configured to be individually adjusted to select a first subset of the second array of openings for providing the vacuum to hold one of the workpieces and to subsequently select a second subset of the second array of openings for providing the vacuum to hold an additional one of the workpieces.

21. The system of claim 17, wherein each linear valve includes a leadscrew and a piston both disposed inside the manifold, the piston being moved along a length of the manifold by rotation of the leadscrew to select the one or more of the multiple openings in the manifold when the linear valve is adjusted.

22. The system of claim 21, further comprising a motor associated with each linear valve and configured to adjust the linear valve by driving the rotation of the leadscrew and thereby moving the piston along the length of the manifold.

23. The system of claim 22, wherein the motor is an indexable motor.

24. The system of claim 17, wherein the vacuum holder one or more of a vacuum chuck, a vacuum table, or a top plate.

25. The system of claim 17, wherein the multiple linear valves are adjacently positioned such that the multiple openings in their respective manifolds are arranged to form the second array of openings.

26. The system of claim 17, wherein the second array of openings is aligned with the first array of openings such that vacuum applied through one of the openings in the second array of openings is applied through a corresponding opening in the first array of openings.

27. The system of claim 17, wherein the workpieces include photovoltaic devices.

28. A method for holding workpieces in place during processing, comprising:
providing a system of linear valves positioned below a vacuum holder on which one or more of the workpieces are placed during processing, the vacuum holder having a first array of openings and the system of linear valves having a second array of openings aligned with the first array of openings;
dynamically selecting a subset of openings from the second array of openings for which a path to a vacuum source is to be provided by adjusting one or more of multiple linear valves included in the system of linear valves, the subset of openings from the second array of openings being selected based on a number of the workpieces to be held in place on the vacuum holder; and
applying a vacuum provided by the vacuum holder through the subset of openings from the second array of openings and through their respective openings in the first array of openings in the vacuum holder.

29. The method of claim 28, wherein adjusting the one or more of multiple linear valves included in the system of linear valves includes adjusting, for at least one of the linear valves, a position of a piston within a manifold of each linear valve to enable one or more openings in the manifold of that linear valve to be part of the subset of openings and have a path to the vacuum source while remaining openings in the manifold of that linear valve are isolated from the vacuum source.

30. The method of claim 29, wherein adjusting the position of the piston within the manifold includes rotating a leadscrew to move the piston along the length of the manifold to the position, the leadscrew being rotated by running a motor coupled to the leadscrew.

31. The method of claim 28, wherein dynamically selecting the subset of openings from the second array of openings for which a path to the vacuum source is to be provided includes increasing a number of openings selected for the subset of openings from the second array of openings when additional workpieces are to held in place for processing.

32. The method of claim 28, further comprising disabling the application of the vacuum when the processing is completed and returning the multiple linear valves included in the system of linear valves to a default position.

33. The method of claim 28, wherein the workpieces include photovoltaic devices.
